(19) United States
(12) Patent Application Publication
(10) Pub. No.: US 2019/0191671 A1
(43) Pub. Date: Jun. 27, 2019

(54) FEEDERS WITH HIGH EFFICIENCY

(71) Applicant: SAGLAMIS ÇELIK TEL VE MAMÜLLERI SANAYI VE TICARET A.S., Sakarya (TR)

(72) Inventor: Ali Kemal BOZDURGUT, Sakarya (TR)

(73) Assignee: SAGLAMIS ÇELIK TEL VE MAMÜLLERI SANAYI VE TICARET A. S., Sakarya (TR)

(21) Appl. No.: 16/325,392

(22) PCT Filed: Feb. 28, 2017
(86) PCT No.: PCT/TR2017/000034

§ 371 Date: Feb. 14, 2019

(30) Foreign Application Priority Data
Aug. 15, 2016 (TR) 2016/11464

(51) Int. Cl. A01K 39/012

(52) U.S. Cl. CPC A01K 39/012

(57) ABSTRACT

A high-yield feeder basically connected with a driving engine is provided, and the high-yield feeder includes at least one transfer part for ensuring a movement of the high-yield feeder, a feeder body and the carrying wings for carrying the feed.

### CROSS REFERENCE TO THE RELATED APPLICATIONS

This application is the national phase entry of International Application No. PCT/TR2017/000034, filed on Feb. 28, 2017, which is based upon and claims priority to Turkish Patent Application No. 2016/11464, filed on Aug. 15, 2016, the entire contents of which are incorporated herein by reference.

### TECHNICAL FIELD

Our invention is about increasing the lifespan and productivity of feeders used to transfer the feed for animals especially in poultry-houses.

### BACKGROUND

Today, usually spirals are used in order to transfer the feed in poultry-houses. In the feed that are transferred with spirals, poor-quality feed is given in the form of grinded dust, and this causes imbalanced nutrition in poultry animals. In addition, sometimes there appear occlusions in the spirals because of the feed, and spiral spring becomes stuck. Although the S-Type feeders that were developed later partly solved the problems, the thickness of the wires had a limiting effect on the transfer and did not provide a complete solution for the problems.

### SUMMARY

With our invention, the aim is to end the problems like feed jamming, feed becoming dust and grinded and poor quality feed will be eliminated, and the feed in good quality is transferred without any disruptions in the desired amount.

In this way, all of the animals in the poultry-house will receive feed with the same quality and in the same amount, and therefore, they will grow in the same quality and the yield will increase. This invention will directly affect the profitability of the plant using the feeder.

### BRIEF DESCRIPTION OF THE DRAWINGS

Our invention, the feeder with high yield is given in the figure in appendix.

FIG. 1: Perspective View of the High-yield Feeder.

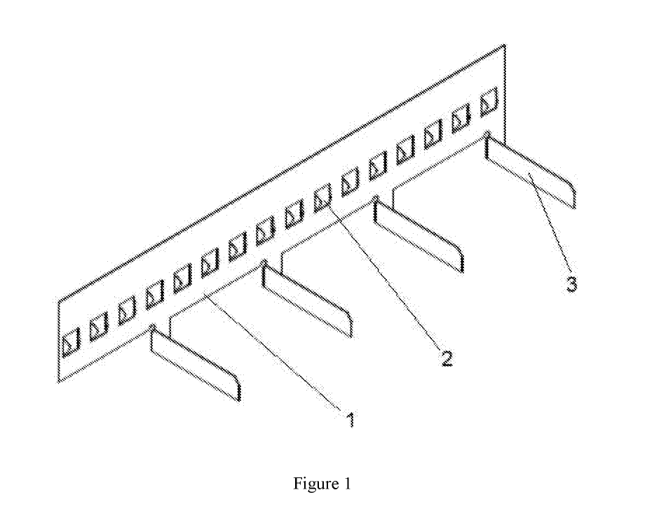

The parts in the figure are given numbers and the corresponding parts are as follows;

(1) Feeder Body

(2) Transfer Part

(3) Carrying Wing

### DETAILED DESCRIPTION

Our invention, the high-yield feeder basically connected with the driving engine and consists of a transfer part (2), which ensures the movement of the feeder, the feeder body (I) and the carrying wings (3) that carry the feed.

The gears on the driving engine enter the transfer parts (2) positioned in the middle of the feeder body (1) that are in accordance with itself and ensures that feeder is moved. With this movement, the feed in the carrying wings (3) are transferred to the feed pots. The carrying wings (3) are positioned below the transfer parts (2) and are disposed at the bottom of the feeder body (1). The height of the carrying wings (3) and their numbers may vary according to the intensity and volume of the feed to be transferred.

The high-yield feeders developed are produced from metal or plastic-based materials, and endure acidic effects in the working environment, which makes them have longer service lives than known feeders.

In addition, since high-yield feeders do not include any additional joints or mounting parts, there is no risk of breakdown.

In terms of production costs, the high-yield feeders may be produced in more economic conditions than the present feeders, and may be used without any problems in poultry-houses and farms for animals.

What is claimed is:

1. A high-yield feeder used to transfer feed, wherein the high-yield feeder is in connection with a driving engine, and the high-yield feeder comprises a feeder body at least one transfer part, and carrying wings; the transfer part is positioned in a middle of the feeder body for ensuring a movement of the high-yield feeder; and the carrying wings are positioned below the transfer parts and are disposed at a bottom of the feeder body for carrying the feed.

2. (canceled)

3. The high-yield feeder according to claim 1, wherein a number of the carrying wings and a height of each carrying wing are predetermined according to intensity and volume of the feed.

4. The high-yield feeder according to claim 1, wherein all components of the high-yield feeder are produced from metal or plastic-based materials.
